(19) United States
(12) Patent Application Publication
(10) Pub. No.: US 2016/0227714 A1
(43) Pub. Date: Aug. 11, 2016

(54) SYSTEM FOR DISPENSING AGENTS TO AGRICULTURAL OR FORESTRY PRODUCTS

(71) Applicant: RKW SE, Frankenthal (DE)

(72) Inventors: Jan Eubeler, Grosskarlbach (DE); Leonhard Maier, Babensham (DE); Robert Voggenauer, Wasserburg (DE); Paul Waller, Rosenheim (DE); Tilo Wachs, Remagen (DE)

(73) Assignee: RKW SE, Frankenthal (DE)

(21) Appl. No.: 15/021,810

(22) PCT Filed: Sep. 13, 2014
(86) PCT No.: PCT/EP2014/002479

§ 371 Date: Mar. 14, 2016

(30) Foreign Application Priority Data
Sep. 17, 2013 (DE) 10 2013 015 323.9

(51) Int. Cl. A01G 9/14; A23B 7/153; A01G 23/00; A01G 13/02; A01G 1/00

(52) U.S. Cl. CPC A01G 9/1438; A01G 13/025; A01G 1/001; A01G 23/00; A23B 7/153; A01G 2013/006

(57) ABSTRACT

The invention relates to a system for dispensing agents to agricultural or forestry products. This system includes an adhesive layer (11) containing at least one agent (12). The adhesive layer (11) adheres to a surface (22). The adhesive layer (11) connects a covering layer (13) to the surface (23). The covering layer (13) has a plurality of openings (14) for dispensing the agent (12). The covering layer (13) also has bulges (15) which protrude by a certain height (17) from a plane (16) of the covering layer (13).

### BACKGROUND

The invention relates to a system for dispensing agents to agricultural or forestry products, comprising an adhesive layer containing at least one agent.

The dispensing of agents plays a key role in agriculture and forestry. The agents can be growth enhancers such as fertilizers, plant protection products such as insecticides, fungicides, or herbicides, or growth regulators for inhibiting germination, for example. The agents can be applied while the product is still growing and/or after the product is harvested. Hence according to the meaning of the invention, agricultural or forestry products are to be understood as actively growing plants and/or as already harvested or felled plants and plant parts, such as the fruits, seeds, etc., thereof.

A great many agents in agriculture and forestry are broadcast, for example by spraying liquids or by applying powders or granulars.

DE 199 13 591 A1 thus describes a method for treating a potato warehouse with a germination inhibitor in aerosol form.

Also known are systems in which the agents are dispensed only at a few sites in the form of point sources rather than as uniform vapor clouds. Hence DE 41 01 878 A1 describes a device for dispensing pheromones. Accordingly, pheromone containers are hung at selected sites that serve as point sources for dispensing agents.

EP 0 142 658 A1 describes backings made of organic material with integrated agents. The backings are films. The agent is integrated in the polymer matrix of the film. Such systems only have a very limited capacity to take up agents.

DE 103 29 275 A1 describes an adhesive layer that contains agents. Such systems, in which the agent is incorporated in an adhesive layer, have a distinctly higher uptake capacity compared to film backings. In DE 103 29 275 A1, a composite is described that includes a transferrable adhesive layer and a backing film. The transferrable adhesive layer and the backing film are not permanently connected to one another. The composite consists of two closed backing films between which the agent-containing adhesive layer is disposed. When using the system, one of the backing layers is peeled off so that the adhesive layer is completely exposed. The adhesive layer can dry out rapidly. Another hazard lies in the fact that the adhesive layer may come into direct contact with the products or that the user may touch it. This is problematic because many agents are potential health hazards.

### SUMMARY

The objective to be addressed by the invention is that of providing a system for dispensing agents, which has an adhesive layer with a high capacity for taking up agents. The agent should be dispensed over a prolonged period. Direct contact between the agricultural or forestry products and/or the user and the agent-containing adhesive layer should be prevented. The agents should be able to perform with a maximum possible efficiency. The system should furthermore be distinguished by high reliability and a stable structure. The system should also have appeal to potential customers.

According to the invention, this objective is achieved by the adhesive layer being adhered to a surface and the adhesive layer connecting a covering layer to the surface, wherein the covering layer has a plurality of openings for dispensing the agent and the covering layer has bulges that protrude by a certain height from a plane of the covering layer.

According to the invention, the adhesive layer serves as a carrier for the agent and simultaneously connects a covering layer to a surface.

In a particularly favorable variant of the invention, use is made of adhesives without solidifying mechanisms. Especially well-suited for this purpose are pressure-sensitive adhesives that remain highly viscous and permanently sticky after application.

A homopolymer is suitable as an adhesive layer. In a particularly favorable variant of the invention, polyisobutylene (PIB) is used as an adhesive layer. As an alternative or in addition, a polyurethane and/or PVC-plastisol can also be used as an adhesive layer.

In one variant of the invention, use is made of a biodegradable adhesive. Water-based adhesives are particularly well-suited for this purpose.

The adhesive layer adheres to a surface. This surface can be the surface of an object.

The surface can also be formed by another covering layer, which also has openings. In this variant of the invention, the adhesive layer connects two covering layers to each other. This gives rise to a composite with a middle adhesive layer and two outer covering layers. Agent can thus be dispensed from the adhesive layer on two sides via the openings in the covering layers.

In a particularly advantageous variant of the invention, the surface is a closed backing layer, preferably a film made of polyethylene, polypropylene, polystyrene, polyethylene terephthalate, polyvinyl chloride, polylactide, thermoplastic polyurethane, or coated cellophane as well as blends.

In a favorable variant of the invention, the backing film is formed, at least in part, of a biodegradable polymer, preferably an aliphatic polyester, in particular an aromatic-aliphatic polyester. In a variant, the backing layer consists of a blend of polylactic acids (PLA) and at least one aromatic-aliphatic copolyester.

The adhesive layer connects the backing layer to the covering layer. In a variant of the invention, an adhesive layer adheres to both sides of a backing layer, wherein each adhesive layer connects a respective covering layer to the backing layer. This gives rise to a composite in which the backing layer is sandwiched between two adhesive layers and two outer covering layers. Agent can thus be dispensed from the adhesive layers on both sides via the openings in the covering layers.

In the system of the invention, the covering layer is permanently connected to the surface via the adhesive layer. When the system is in use, the covering layer stays on the adhesive layer and protects the products and the user from direct contact with the adhesive layer during application. The adhesive layer is furthermore kept from drying out. To allow the agent to migrate out of the adhesive layer, the covering layer has a plurality of openings through which the agent exits.

The covering layer is preferably comprised of a thermoplastic material, which except for the openings is otherwise closed. It turns out to be particularly advantageous if the covering layer is comprised of a polyolefin. Polyethylene or polypropylene, but also polystyrene, polyethylene terephthalate, polyvinyl chloride, polylactide, thermoplastic polyurethane, or coated cellophane as well as blends thereof are examples of suitable materials for the covering layer.

In a favorable variant of the invention, the covering layer is comprised of a biodegradable polymer, preferably an aliphatic polyester, in particular an aromatic-aliphatic polyester. In a variant of the invention, the covering layer is comprised of a blend of polylactic acids (PLA) and at least one aromatic-aliphatic copolyester.

Except for the openings, the covering layer has a surface that is impermeable to the agent. The area of the surface through which the agent can exit is termed the “open area.” The “open area” is preferably greater than 2%, preferably greater than 3%, in particular greater than 4%. The “open area” is preferably less than 50%, in particular less than 40%. It turns out to be particularly favorable if the “open area” is in the range of 4 to 35%.

The covering layer has bulges that protrude by a certain height from a plane of the covering layer. These bulges create spacers to the adhesive layer. Contact between the agricultural and/or forestry product and/or the user and the agent-containing adhesive layer is prevented in a particularly effective manner by this design.

In a particularly favorable embodiment of the invention, the bulges form the openings. To this end, each bulge has a wall that forms a cavity and encloses an opening. Bulges of this kind can be cylindrical, conical, and/or hyperboloid formations, which protrude upward from the plane of the covering layer and whose edges form the openings from which the agent exits. Preference is given to elongate, tunnel-like capillary tubes through which the agent migrates.

The walls of the bulges form snorkels that guide the agent from the adhesive layer to the opening. The cavities protect against effects of, for example, air currents so that the agent can initially accumulate in the capillary tube-like cavities. The efficiency of the system is thus improved.

In a particularly advantageous embodiment of the invention, the bulges are created in the covering layer by guiding thermoplastic material over an element that has holes. Preference is given to the element being a rotating roller. The roller has bores as holes. By means of a vacuum pump, a pressure differential is created such that the thermoplastic material is pulled into the holes. The thermoplastic material is thus thinned out in the area of the holes such that openings form in the covering layer. A covering layer with bulges thus forms as the thermoplastic material cools. This vacuum-perforated covering layer is then connected to a surface via an adhesive layer containing an agent.

The thermoplastic material can be guided over the element in various ways. In one variant, molten thermoplastic material is extruded onto the element. In this process the thermoplastic polymer film is fed in molten form into a vacuum perforating device. The polymer film is sucked into the holes by a vacuum, wherein the molten polymer forms elongate cavities in the shape of capillary tubes. After the film cools, the vacuum-perforated covering layer is removed and connected to another layer by an adhesive layer.

In another variant of the method, a thermoplastic film is heated and guided over an element that has holes. Negative pressure is applied here as well. In the area of the holes the heated film is pulled in such that bulges form, said bulges having walls that form elongate cavities and enclose openings.

The height of the bulge is preferably greater than the thickness of the plane of the covering layer by a factor of 5, in particular by a factor of 10. The height of the bulge is preferably greater than 100 μm, in particular greater than 300 μm. This gives rise to elongate capillary tubes with an air-filled cavity in which the agent accumulates. The height of the bulges is preferably less than 1500 μm, in particular less than 1000 μm.

The bulges can be conically configured such that the narrowest cross section is formed by the outer edge of the bulge. Cylindrical bulges in which the cross section of the cavity stays essentially constant can also be formed.

The bulges have constrictions in a particularly advantageous embodiment of the invention. Starting from a narrowest cross section, the free cross section of the cavity widens toward the opening.

In a variant of the invention, the plane of the covering layer rests on the adhesive layer and the bulges protrude outward from the adhesive layer. The agent enters the cavities of the bulges from the adhesive layer and then exits through openings formed by the outer edge of the bulges.

In an alternative variant of the invention, the plane of the covering layer is arranged at a distance from the adhesive layer. The bulges protrude from the plane of the covering layer toward the adhesive layer. The openings lie in the plane of the covering layer, whereas the edges of the bulges protrude to the adhesive layer. In this variant of the invention, spaces in which the agent accumulates are formed between neighboring bulges.

The outer edge of the bulges preferably has an irregularly lobed and/or folded shape. Agent-rich air is thus able to diffuse from the spaces between neighboring bulges and into the cavities of the bulges, and then exit through the openings.

During the manufacturing of the system, the adhesive is applied to the covering layer and/or to the surface as an adhesive layer. The adhesive can be applied to a surface configured as a closed backing layer by an anilox roller, for example. The adhesive can also be applied to the backing layer by doctoring. The backing layer and the covering layer are then laminated to one another via the adhesive layer.

A particularly pleasant feel, a so-called “soft touch” feel, is achieved by means of the relatively high bulges.

### BRIEF DESCRIPTION OF THE DRAWINGS

Other advantages and features of the invention will emerge from the description of exemplary embodiments with reference to drawings, as well as from the drawings themselves. Shown are:

FIG. 1 a side view of a system for dispensing agents in a warehouse,

FIG. 2 a front view of a system for dispensing agents in a warehouse,

FIG. 3 a system for dispensing agents over bulk goods,

FIG. 4 a sectional view through a composite with a covering layer, whose bulges are protruding away from the adhesive layer,

FIG. 5 a section through a composite with a covering layer, whose bulges are protruding toward the adhesive layer,

FIG. 6 a schematic illustration of a method for producing the covering layer,

FIG. 7a the covering layer during the manufacturing process, in an initial stage,

FIG. 7b the covering layer during the manufacturing process, in a final stage,

FIG. 7c a section through the cooled covering layer.

### DETAILED DESCRIPTION OF THE PREFERRED EMBODIMENTS

FIG. 1 schematically shows a warehouse for agricultural or forestry products with a storeroom floor 1. Holding systems 3 are positioned at a certain height 2 from the storeroom floor 1. A composite 4 extends as a path guided alternatingly between the holding systems 3 and the storeroom floor 1. The holding systems 3 in the exemplary embodiment are beams that are arranged in the warehouse.

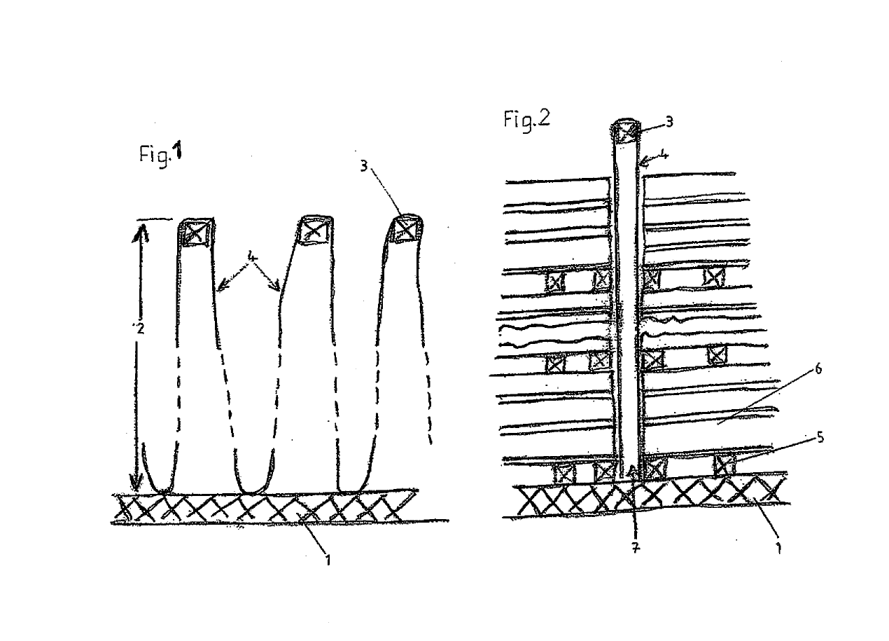

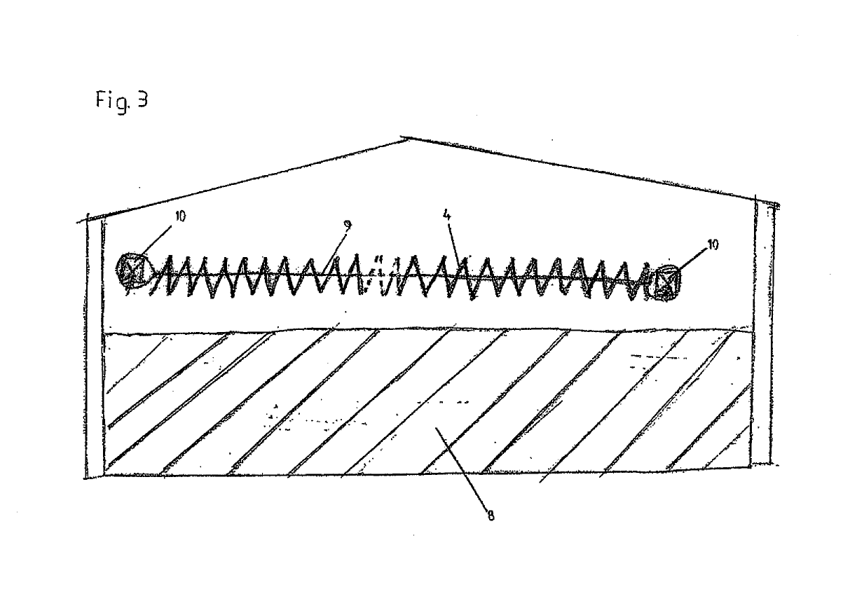

FIG. 2 shows a warehouse with a storeroom floor 1, on which pallets 5 and crates 6 are alternatingly stacked on top of one another. A crate alley 7 runs between them. A system for dispensing agents is positioned within the crate alley 7. This system is the composite 4 that runs between the holding systems 3 and the storeroom floor 1. The crates 6 are filled with agricultural products such as potatoes.

FIG. 3 shows a system for dispensing agents, which is positioned above bulk goods 8 consisting of agricultural products (e.g., potatoes). A composite 4 is arranged on a guide element 9, which runs between two fasteners 10. The composite 4 is strung on the guide element in the form of a folded path. The guide element 9 in the exemplary embodiment is a steel cable, which is tensioned between the two fasteners 10.

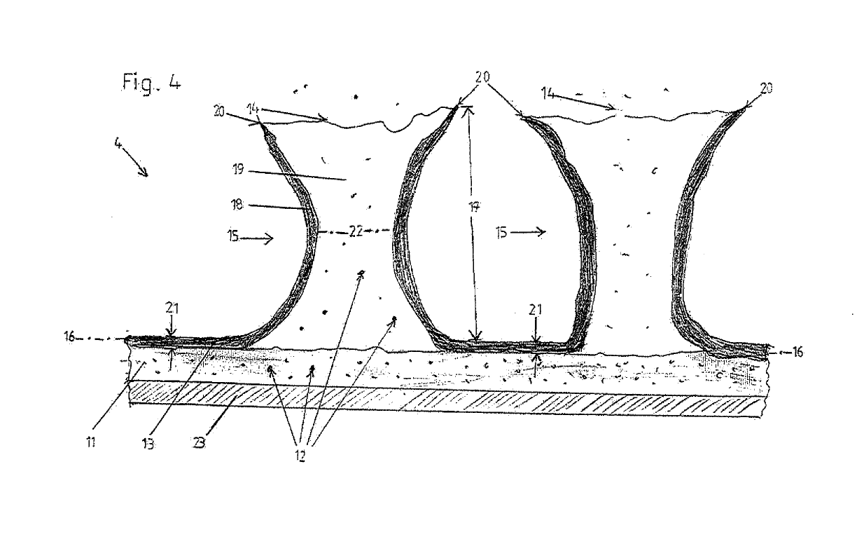

FIG. 4 shows a schematic illustration of a composite 4. The composite 4 comprises an adhesive layer 11, which contains an agent 12. The agent 12 is illustrated purely schematically as black dots. The adhesive layer 11 is permanently connected to a covering layer 13. The covering layer 13 is comprised of a thermoplastic material and has a plurality of openings 14 for dispensing the agent 12. A polyethylene or polypropylene film is used as a covering layer 13 in the exemplary embodiment.

The adhesive layer 11 in the exemplary embodiment is composed of polyisobutylene (PIB) and contains up to ten weight percent of a growth regulator as an agent 12. The growth regulator in the exemplary embodiment is isopropyl-N-(m-chlorophenyl)-carbamate. As an alternative, use can also be made of 1K- and/or 2K-polyurethane systems for the adhesive layer 11.

The covering layer 13 has bulges 15, which protrude by a certain height 17 from a plane 16 of the covering layer 13.

Each bulge 15 has a wall 18 that forms a cavity 19 and encloses and opening 14. The openings 14 are enclosed by the outer edges 20 of the bulges 15. The cavities 19 extend from the adhesive layer 11 to the openings 14.

The heights 17 of the openings 15 are greater than the thickness 21 of the plane 16 of the covering layer 13 by more than a factor of 5, in particular by more than a factor of 10.

The cavities 19 in the exemplary embodiment have a narrowest cross section 22. Starting from this narrowest cross section 22, the cross section of the cavities 19 widens toward the openings 14 and/or toward the adhesive layer 11. The cross section delimited by the outer edge 20 of each bulge 15 forms the opening 14. The cross section of the opening 14 is larger than the narrowest cross section 22 of a cavity 19.

The plane 16 of the covering layer 13 forms the smooth side of the covering layer 13. The bulges 15 of the covering layer 13 form the textured side of the covering layer 13, which has a three-dimensional design.

The cross section of the cavity 19 increases in the axial direction from the site of the narrowest cross section 22 to the free edge 20 of the bulges 15. The narrowest cross section 22 of the cavity 19 is positioned in a plane that is adjacent to the plane 16 of the covering layer 13 and which is situated at a distance from the free edge 20 of the bulges 15.

The outer edge 20 of the bulges 15 has an irregularly lobed or folded shape. In the exemplary embodiment illustrated in FIG. 4, the plane 16 of the covering layer 13 rests on the adhesive layer 11.

The adhesive layer 11 connects the covering layer 13 to a surface 23. The surface 23 is a backing layer that is comprised of polyethylene in the exemplary embodiment.

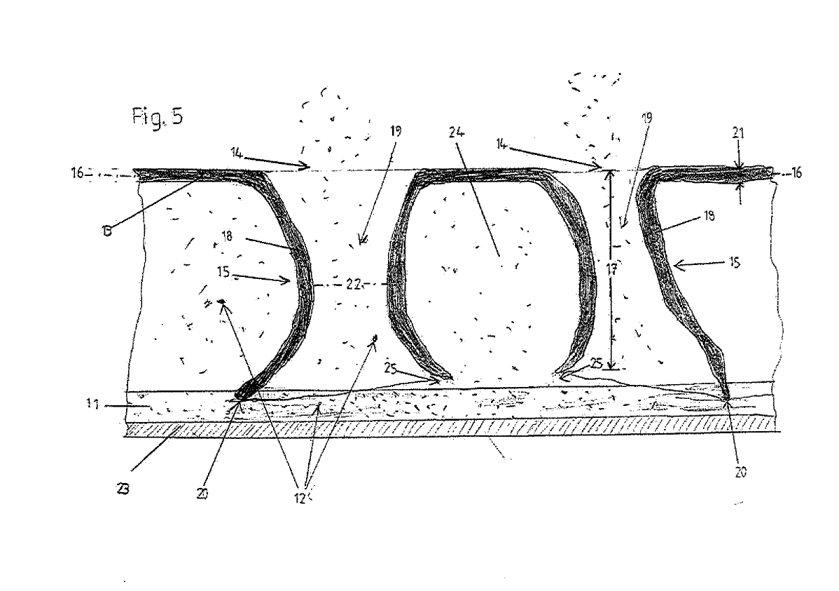

FIG. 5 shows a variant of the invention in which the openings 14 are arranged in the plane 16 of the covering layer and the bulges 15 protrude toward the adhesive layer 11. In the variant illustrated in FIG. 5, the plane 16 is arranged at a distance from the adhesive layer 11. The outer edge 20 of the bulges 15 protrudes at least partially into the adhesive layer 11.

Spaces 24 are thus formed between neighboring bulges 15. The agent 12 accumulates in the spaces 24. Because the outer edge 20 of the bulges 15 has an irregular structure, there are connection sites 25 through which the agent 12 migrates out of the spaces 24 and into the cavities 19 and is then dispensed via the openings 14. With this design, the efficacy is increased while the system is in use due to the fact that the volatile agent 12 is concentrated. This is particularly advantageous with agents 12 that have a relatively low vapor pressure.

Several steps are employed in the method of the invention for manufacturing a system for dispensing agents. The agent 12 is incorporated in an adhesive. The agent 12 can be a growth regulator such as a germination inhibitor, a fertilizer, a plant protection product such as a fungicide, a herbicide, or an insecticide, or pheromones.

In the process diagram illustrated in FIG. 6, the covering layer 13 according to the invention is produced from a polymer film 25 in the molten state. This type of production is also known as “inline perforation.” As already mentioned, the covering layer 13 can also be produced from a heated film, wherein such a process is then known as “offline perforation”.

In inline perforation, the molten polymer film is applied from a sheet the 26 to an element 27 having holes. The element 27 in the exemplary embodiment is a rotating cylinder with boreholes. A pressure differential is generated by a vacuum generator 28. The polymer film 25 is sucked into the perforated cylinder by the vacuum generator 28. The molten polymer is thus configured as elongate bulges 15.

After the film is cooled by a cooling unit 29, the covering layer 13 is discharged by a roller 30.

The covering layer 13 is then connected by the agent-containing adhesive to a surface 23 configured as a backing layer. To this end, an adhesive layer 11 is applied to the backing layer by an anilox roller (not illustrated). The backing layer is laminated with the covering layer 13.

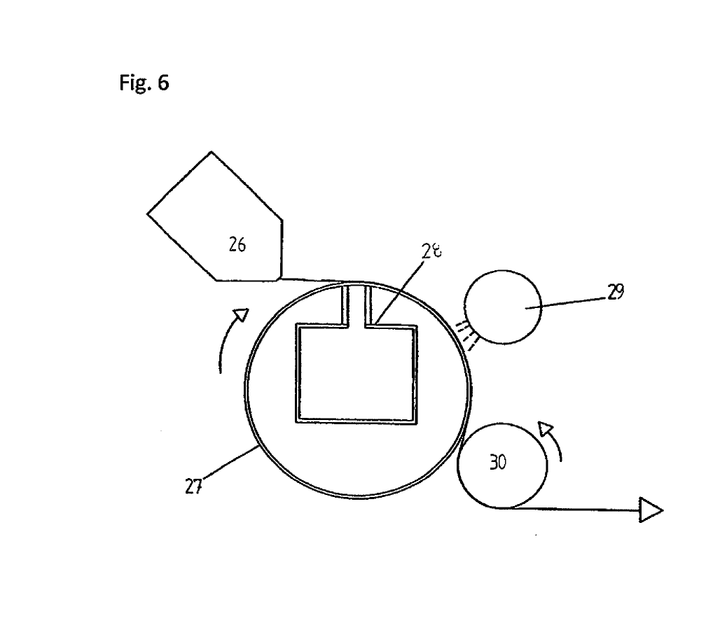

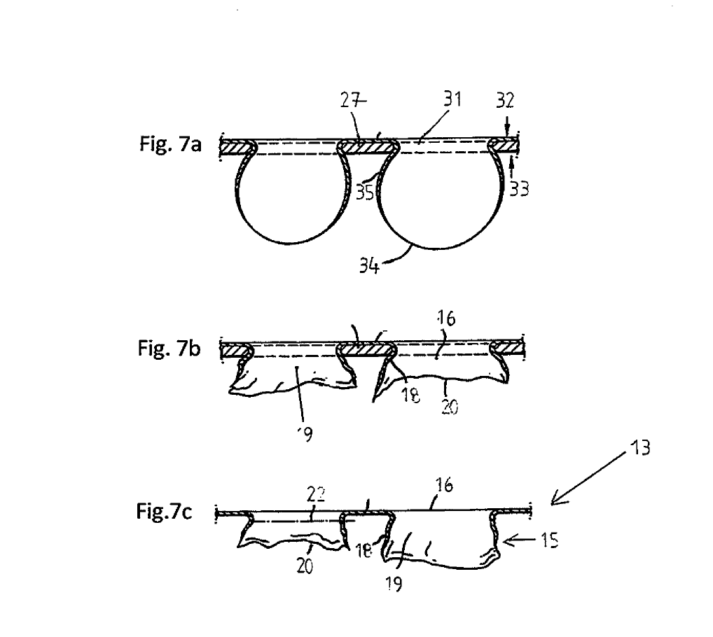

FIGS. 7a and 7b show two stages during the process of manufacturing the covering layer 13. Holes 31 are evenly distributed on the element 27, the thickness of which is of an order of 0.2 mm. The holes 31 have a diameter greater than 0.4 mm, in particular greater than 0.6 mm and less than 1.2 mm, in particular less than 1.0 mm. In the illustrations according to FIGS. 7a and 7b, a hot plastic film is applied, the initial thickness of which is preferably between 15 μm and 70 μm.

By the differential pressure acting from the top side 32 of the film to the underside 33 of the film, the film material is forced through the holes 31 and shaped into bubbles 34. The diameter of the bubbles is greater than the diameter of the holes 31. In an area 35, the film material is thus deformed laterally beyond the boundaries of the holes.

As a consequence of the degree of deformation in excess of the degree of elasticity and due to the cooling that the film material undergoes, particularly in the area of contact near the element 27, there is only a limited amount of resilience. In the area 35, the larger diameter of the bubble material exceeding the diameter of the holes is mostly retained, whereas to a large extent the portion of material that formerly formed the dome of the bubble contracts toward the area 35. Because the process of bursting does not progress in a geometrically uniform manner, an edge 20 with a lobed, wavy, uneven, fissured and/or creased structure is formed.

When the film is removed from the element 27 in the further course of the process, the bulges 15 thus formed pull out of the holes 31 of the element 27 but retain the expanded edge shape illustrated in FIG. 7c, which contributes to the particularly advantageous performance.

The shape of the cavities 19 is defined in that starting from the plane 16, the diameter thereof decreases toward the narrowest cross section 22 and then increases toward the edge 20. The narrowest diameter of the cavity expediently ranges from 0.2 to 2 mm, preferably from 0.3 to 1.3 mm.

The covering layer 13 is exceptionally agreeable to the skin. This is due to the relative large ratio of the opening surface area to the total surface area. The covering layer 13 is soft yet stretch resistant. The softness is due to the flexibility of the thinned-out bulge edges. The good strength values are attributable to the fact that the zones of the smallest diameter of the bulges, in which the greatest stresses arise when the film is stretched, do not form the openings at the same time and are therefore not weakened by notching effects or portions of particularly low material density.

As material for producing the covering layer 13, preference is given to polyolefins, including homopolymers, mixtures of homopolymers, copolymers, mixtures of different copolymers, as well as mixtures of copolymers and homopolymers.

1. A system for dispensing agents to agricultural or forestry products, said system comprising an adhesive layer (11) that contains at least one agent (12), the adhesive layer (11) is adhered a surface (23) and (11) connects a covering layer (13) to the surface (23), the covering layer (13) has a plurality of openings (14) for dispensing the at least one of agent (12) and the covering layer (13) has bulges (15), which protrude by a predetermined height (17) from a plane (16) of the covering layer (13).

2. The system as claimed in claim 1, wherein the openings (14) are formed by the bulges (15).

3. The system as claimed in claim 2, wherein each of the bulges (15) has a wall (18) that forms a cavity (19) and encloses one of the openings (14).

4. The system as claimed in claim 1, wherein the predetermined height (17) of the bulges (15) is greater than a thickness (21) of the covering layer at the plane (16) of the covering layer (13) by more than a factor of 5.

5. The system as claimed in claim 1, wherein the height (17) of the bulges (15) is greater than 100 μm.

6. The system as claimed in claim 5, wherein the height (17) of the bulges (15) is less than 1500 μm.

7. The system as claimed in claim 3, wherein starting from a narrowest cross section (22), the cross section of the cavity (19) widens toward the opening (14).

8. The system as claimed in claim 1, wherein the bulges (15) protrude away from the adhesive layer (11) and the openings (14) are formed from an outer edge (20) of the bulges (15).

9. The system as claimed in claim 1, wherein the bulges (15) protrude toward the adhesive layer (13) and the openings (14) are arranged in the plane (16) of the covering layer (13).

10. The system as claimed in claim 9, wherein spaces (24) are formed between neighboring bulges (15).

11. The system as claimed in claim 1, wherein an outer edge (20) of the bulges (15) has at least one of an irregularly lobed or folded shape.

12. A method for manufacturing a system as claimed in claim 1, comprising the following steps:
incorporating the at least one agent (12) in an adhesive,
guiding a thermoplastic material over an element (27) that has holes (31),
pulling the thermoplastic material into the holes (31) via a differential pressure,
thinning out the thermoplastic material in an area of the holes (31) and forming openings (14),
forming the covering layer (13) with the bulges (15) as the thermoplastic material is cooled,
connecting the covering layer (13) to the surface (23) via the adhesive that contains the at least one agent.

13. The method as claimed in claim 12, wherein the thermoplastic material is applied to the element (27) in molten form.

14. The method as claimed in claim 12, wherein the thermoplastic material is guided over the element (27) as a heated film.

15. The method as claimed in claim 12, wherein the adhesive is applied to the surface (23) or to the covering layer (13) or both as the adhesive layer (11).
